(19) United States
(12) Patent Application Publication
(10) Pub. No.: US 2015/0188178 A1
(43) Pub. Date: Jul. 2, 2015

(54) Safety System for a Flow Battery and Flow Battery System

(71) Applicant: Robert Bosch GmbH, Stuttgart (DE)

(72) Inventors: Edward Knudsen, Menlo Park, CA (US); Paul Albertus, Washington, DC (US)

(21) Appl. No.: 14/565,677

(22) Filed: Dec. 10, 2014

Related U.S. Application Data
(60) Provisional application No. 61/921,237, filed on Dec. 27, 2013.

(51) Int. Cl. H01M 8/18; H01M 2/12; H01M 8/04; H01M 8/20

(52) U.S. Cl. CPC H01M 8/188; H01M 8/20; H01M 2/1223; H01M 8/04201; H01M 8/0444; H01M 8/04365; H01M 8/0438; H01M 8/04791

(57) ABSTRACT

A flow battery system includes a safety system and method for maintaining a safe operation of a flow battery and the flow battery system. The system and method are configured to provide for the safe operation of flow batteries with chemistries involving hydrogen (H₂) gas. Oxygen sensors and other temperature and gas concentration sensors are placed at active material storage tanks and connected to an electronic control unit. Feedback from the sensors is used to ensure that the battery system appropriately and rapidly responds to the development of conditions that might lead to volatility. These responses include discontinuing battery operation, engaging pressure relief valves, and engaging oxygen removal systems.

### CROSS REFERENCE TO RELATED APPLICATIONS

This application claims the benefit of U.S. Provisional Application No. 61/921,237, filed Dec. 27, 2013, the disclosure of which is incorporated herein by reference in its entirety.

### GOVERNMENT RIGHTS NOTICE

This invention was made with government support under DE-AR0000137 awarded by the Department of Energy Advanced Research Projects Agency-Energy. The government has certain rights in the invention.

### FIELD OF THE INVENTION

This disclosure relates generally to the field of rechargeable batteries and more particularly to flow batteries and flow battery systems.

### BACKGROUND

As intermittent renewable energy sources such as wind and solar increase their share of overall energy production, a method is required to make up for their intermittency and match the demand on the grid in real time. Numerous methods have been discussed to stabilize intermittent renewables, including grid extension to average over larger sets of intermittent assets, demand-side management, ramping of conventional assets, and finally energy storage (including technologies such as electrochemical storage, thermal storage, power to gas, etc.). Flow batteries are one of the technologies under consideration for electrical energy storage, in addition to numerous other electrochemical storage technologies such as lithium-ion (Li-ion), sodium-sulfur (Na/S), and sodium-nickel chloride (Na/NiCl₂). While the most prominent flow battery couple is the one making use of vanadium at different oxidation states at each electrode, there are many other couples under consideration, with reactants in the gas, liquid, and solid forms.

One promising flow battery reacts hydrogen (H₂) and bromine (Br₂) to form hydrogen bromide (HBr) on discharge. The main advantage of this couple is that, when catalyzed, the H₂ reaction is kinetically rapid, and the Br₂ reaction is rapid even when uncatalyzed. Rapid kinetics and the ability to obtain components from the related system reacting H₂ and oxygen (O₂) in a proton-exchange membrane fuel cell have allowed the H₂/Br₂ chemistry to achieve a very high power density. A high power density reduces the area required for a given amount of power and holds promise for cost reductions, as the system cost has a significant dependence on the total area over which the reactions are carried out. While the H₂/Br₂ system has been shown to have a high power density, numerous challenges remain, including limiting the degradation of cell components (which is exacerbated by the crossing of the H₂, Br₂, and HBr through the ion-exchange membrane that is typically used, as well as the strongly acidic nature of the HBr solutions that are used), to provide for safe operation, and achieving a low-cost design. Other chemistries making use of hydrogen gas can also have favorable characteristics, including H₂/Cl₂.

FIG. 1 provides a schematic diagram of a prior art flow battery cell 100 including a number of cell layers included in the cell 100. The discharge reactions are indicated, but can also be reversed for charging. Hydrogen gas is sent into a negative electrode 102, where a porous medium 104 and a catalyst layer 106 (typically made of Platinum (Pt) to catalyze H₂ oxidation on discharge and H+ reduction on charge) are present. During discharge, H+ is produced from the H₂ gas and passes through a membrane 108 to a positive electrode 110, where it is combined with Br— to form HBr. The membrane 108, in some embodiments, is an ion-exchange membrane, such as the cation-exchange membrane Nafion, or a separator with pores through which the H+ passes. On the positive electrode side a solution composed of Br₂ and HBr is delivered to and flows by the positive electrode 110. The positive electrode is porous, and the catalyst 106 layer is optional, as the kinetics of the Br₂ reaction (Br₂+2e−→2Br— on discharge, 2Br-→Br₂+2e− on charge) are fast, even on uncatalyzed carbon. The presence of HBr, which typically dissociates to form H+ and Br—, allows for the conduction of ionic current within the porous electrode. The electrons are passed through an external circuit (111), where useful work can be extracted (discharge) or added (charge) to the circuit.

Safety issues should be considered in the design, manufacture, and operation of flow battery systems which use H₂ gas as an active material. For example, a typical H₂/Br₂ flow battery can employ large quantities of H₂, which can be pressurized, often at high pressures, to reduce or minimize volumetric storage requirements. Such a highly pressurized H₂ system often presents safety issues because H₂ is a particularly volatile material, especially when mixed with oxygen.

Consequently, what is needed is a system and method to provide for the safe operation of flow batteries having chemistries involving volatile gases, and in particular H₂ gas.

### SUMMARY

In accordance with one aspect of the disclosure, a flow battery system that includes one or more oxygen sensors can be operated more safely than prior art flow batteries.

In accordance with another aspect of the disclosure, a flow battery system that includes one or more gas and/or temperature sensors can be operated more safely than prior art flow batteries.

In accordance with another aspect of the disclosure, the safety of a flow battery system is improved by including an automated control system configured to monitor for the development and occurrence of one or more unsafe conditions in the battery system.

In accordance with another aspect of the disclosure, a flow battery system includes an automated control system configured to provide a remedial action to ensure that the control system responds accordingly to correct and/or eliminate an unsafe condition.

In still another aspect of the disclosure, an H₂/Br₂ flow battery system is configured to reduce the risk of catastrophic failure due to the combustion of the active electrochemical materials and species from the atmosphere, such as O₂.

In accordance with another aspect of the disclosure, an H₂/Br₂ flow battery system is configured to include a longer service life though detection of a buildup of oxygen in the flow battery system and which is removed through one or more maintenance or remedial procedures.

In accordance with another aspect of the disclosure, oxygen sensors ensure a safe operation of H₂/Br₂ flow batteries and flow battery systems.

In accordance with still another aspect of the disclosure, oxygen sensors and other temperature and gas concentration sensors are placed in the active material storage tanks and connected to an electronic control unit. Feedback from these sensors is used to ensure that the battery system appropriately and rapidly responds to the development of conditions that might lead to unsafe conditions such as the presence of material combustion. Remedial procedures, in different embodiments include discontinuing battery operation, engaging pressure relief valves, and engaging oxygen removal systems.

### BRIEF DESCRIPTION OF THE DRAWINGS

FIG. 1 is a schematic diagram of a prior art flow battery cell.

FIG. 2 is a schematic diagram of an H₂/Br₂ flow battery system according to the disclosure.

FIGS. 3(a) and 3(b) are graphs of a spontaneous reaction of various mixtures of H₂ and Br₂ after 10 hours as a function of temperature.

FIG. 4 is a schematic diagram of a flow battery system including a safety system.

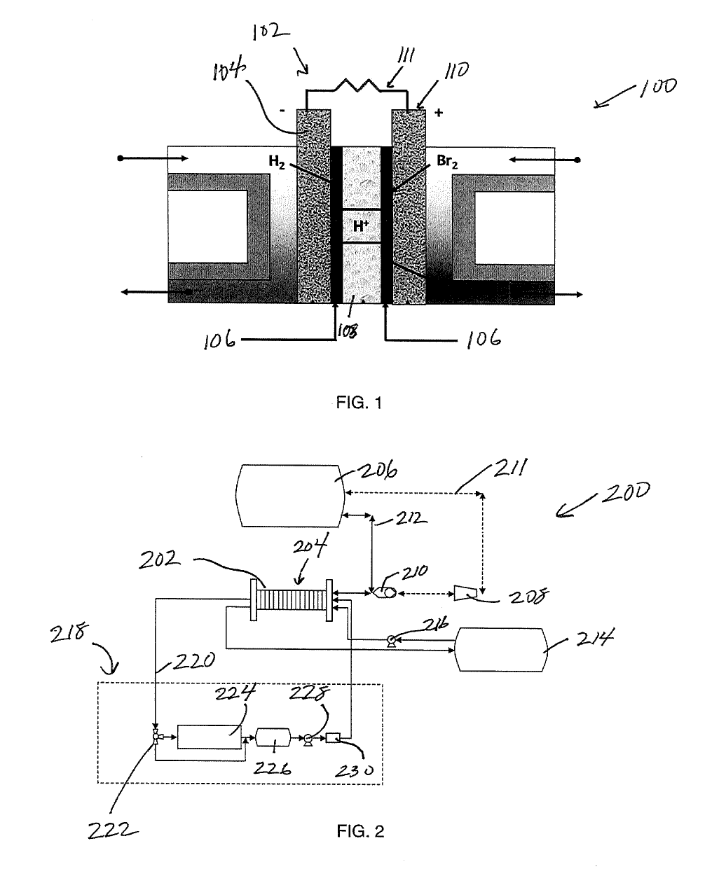

### DETAILED DESCRIPTION

For the purposes of promoting an understanding of the principles of the embodiments disclosed herein, reference is now made to the drawings and descriptions in the following written specification. No limitation to the scope of the subject matter is intended by the references. The disclosure also includes any alterations and modifications to the illustrated embodiments and includes further applications of the principles of the disclosed embodiments as would normally occur to one skilled in the art to which this disclosure pertains.

FIG. 2 illustrates one embodiment of an H₂/Br₂ flow battery system 200 according to the disclosure. A plurality of cells 202 is stacked together to form a battery stack 204. A supply tank 206 for the hydrogen gas H₂ is coupled to a compressor 208 which is coupled to a pressure regulator 210. A mechanical compression line 211, in one embodiment, extends from the tank 206 through the compressor 208, through the pressure regulator 210 and to a hydrogen input of the battery stack 204. In another embodiment, an electrochemical H₂ compression line 212 is provided.

A supply tank 214 stores a hydrogen bromide (Br₂/HBr) solution which is delivered through a pump 216 to a Br₂/HBr input of the battery stack 204. A separate coolant loop 218, in one embodiment, cools the Br₂/HBr solution which flows through the battery stack 204. The coolant loop 218 receives solution at an input 220 which is coupled to a thermostat/valve 222 which either directs the solution through a high temperature radiator 224 or bypasses the radiator 224 to a coolant reservoir 226. Cooled solution is stored in the reservoir for delivery to the battery stack 204 by coolant pump 228 through a coolant DI filter 230. In another embodiment, the Br₂/HBr solution flows directly through a radiator. Electrochemical hydrogen compression or mechanical hydrogen compression can be used to increase the energy density of the system.

In one embodiment, the cells 202 are combined into the battery stack 204. In particular, the tanks 206 and 214 store the Br₂/HBr liquid as well as the H₂ gas. The H₂ gas is pressurized, in one embodiment in order to reduce the volume thereof. Because heat is generated by the system during operation coolant loop 218 is provided for cooling of the solution. A separate cooling loop can be used (in which case cooling fluid is passed through the stack in channels that are isolated from the flows of H₂ and Br₂/HBr), but a more straightforward (and less costly) method for cooling is simply to pass the Br₂/HBr solution through a radiator.

Compression of the H₂ gas, in different embodiments, is accomplished in a number of ways, including electrochemical compression through line 212 or as mechanical compression through line 211, as described above. Electrochemical compression has a higher energy efficiency, but if used, the battery stack 204 operates at an elevated pressure. A battery management system (not shown), in some embodiments, is required to ensure the efficient operation of the H₂/Br₂ battery system. In particular, during discharge of the battery stack 204, a predetermined flow of H₂ and Br₂/HBr is sent through the battery stack 204 wherein the flow is related to the current demanded from the device being supplied with power delivered by the battery stack 204. In addition, during charging of the battery stack 204, a predetermined flow of gas and solution is required to remove the products generated from the cell stack.

The pressure of the stored hydrogen, in different embodiments, ranges from several bar to several hundred bar, depending on the desired energy density of the system, the permissible energy for H₂ compression, and whether the system incorporates a hydrogen adsorption material. The composition of the Br₂/HBr solution is chosen based on several factors including: determining the amount of HBr that needs to be present to allow rapid ionic transport within the solution; determining a sufficient amount of Br₂ such that the size of the Br₂/HBr tank does not become excessive; and determining the point at which HBr concentration increase to a level at which the conductivity of membranes (typically Nafion) of the flow battery stack 204 fall due to dry out. A typical concentration in the fully charged state is 1M Br₂ in 1M HBr, although both higher and lower concentrations can also be used.

An H₂/Br₂ flow battery system, such as the one illustrated in FIG. 2, requires large quantities of H₂ gas to be stored at pressures ranging from tens of bar to several hundred bar. Other flow battery chemistries using H₂ can be subject to similar requirements. However, H₂ gas is known to be an especially volatile material. Consequently, chemical reactions can occur during flow battery operations that pose a safety risk. Hydrogen gas reacts particularly strongly with oxygen, and can also react exothermically with other gases. Table 1 lists the enthalpy change (energy release) of several H₂ gas phase reactions that can occur in flow battery tanks when different battery chemistries are employed. The relative heat release of each reaction is illustrated by the enthalpy change listed in the second column.

TABLE 1

| Chemical Reaction | Enthalpy Change Per Mole H₂ (kJ) |
|---|---|
| H₂ + ½O₂ -> H₂O | −241.8 |
| H₂ + Cl₂ -> 2HCl | −184.6 |
| H₂ + Br₂ -> 2HBr | −72.6 |

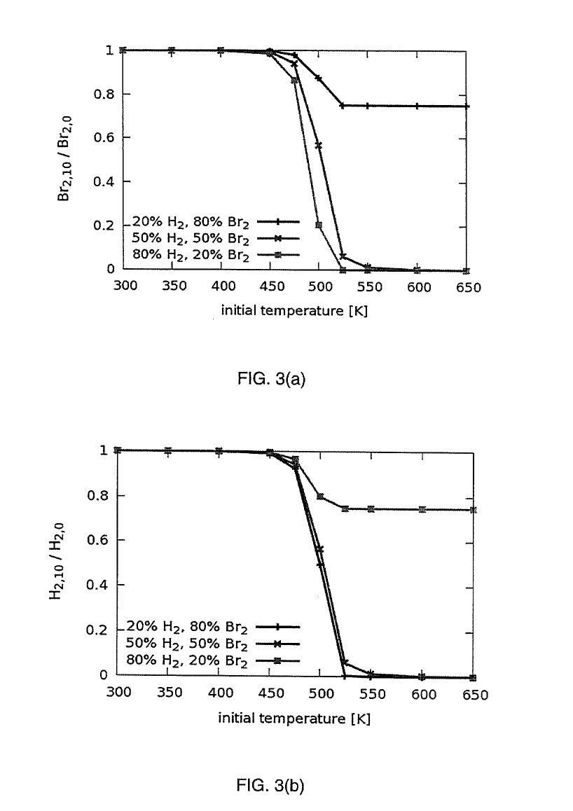

While the reaction products in Table 1 are thermodynamically favored over the reactants, the kinetic rates of these reactions tend to be slower when the pressure and temperature are low and when no catalyst is present. Regarding the issue of temperature, FIGS. 3(a) and 3(b) show the fraction of mixtures of several compositions of H₂ and Br₂ that have reacted spontaneously after ten (10) hours, as a function of temperature. As FIGS. 3(a) and 3(b) show, at temperatures below 400 K there is no significant reaction after 10 hours, while at temperatures above 500K the reaction rate becomes significant. The graphical results indicate that at the temperatures of practical operation, typically less than 373K, there will be no significant reaction between H₂ and Br₂ gases. In other words, while such mixtures are thermodynamically favored to react, the kinetics are too slow for any appreciable amount of reaction to take place. This observation is also true of H₂/O₂ reactions: when the temperature and pressure are low, spontaneous reactions are unlikely to occur. The results depicted in FIGS. 3(a) and 3(b) were obtained using data from the NIST Chemistry Webbook (webbook.nist.gov) and the NIST Chemical Kinetics Database (kinetics.nist.gov).

While the reactions in Table 1 are not expected to interfere with the safe operation of an H₂/Br₂ flow battery or flow battery system under ideal conditions, in real world applications, the actual operation of the H₂/Br₂ flow battery or flow battery system can be subject to conditions or events in which safety is compromised. Some examples of such conditions include: exposure of the battery to particularly high temperatures; the occurrence of a spark inside the battery flow paths due to metal-on-metal contact of fan or pump components; or a battery malfunction that results in particularly large pressure increases or off-design conditions. Under such conditions, safety concerns associated with exothermic reactions can become relevant. As shown in Table 1, the enthalpy released by the reaction of H₂ and O₂ is larger than the enthalpy release associated with the other reactions. Additionally, the kinetics of the H₂ and O₂ system are known to be particularly fast. These observations suggest that storage systems containing O₂ are more likely to experience volatility. Consequently, the addition of O₂ to the mixture in the storage tanks tends to increase the possibility of unsafe conditions developing in the flow battery or flow battery system. Oxygen buildup can occur, for example, if a leak in a flow battery containment system occurs. Particularly close attention must therefore be paid to the possibility of O₂ entering the flow battery, the flow battery system, or components thereof.

Oxygen is not a necessary component required for the operation of an H₂/Br₂ flow battery, and it is therefore preferred that no O₂ gas is in or enters into the battery or battery system when initially put into operation. However, in a typical flow battery system, the only barriers between the active materials and the atmosphere are the walls of the storage tanks, containment vessels or structures, and the seals that are used in the flow delivery system. Consequently, there is some risk that O₂ gas can enter the system through leaks in the pressure containment structures, through electrochemical decomposition of the H₂O molecules that serve as a solvent on the liquid side of a battery system, or through other means or mechanisms. Oxygen can also enter the system during maintenance of the battery or battery system or during the replenishment of an active material.

The possibility of a dangerous chemical reaction between H₂ gas and O₂ gas implies that O₂ buildup should be avoided in flow battery systems and storage tanks. If not, the system can become unsafe to operate and can be prone to catastrophic failure in the presence of small sparks or heat sources. What is therefore needed is a strategy for mitigating the safety risks surrounding the presence of O₂ in flow batteries.

In different embodiments, oxygen concentration sensors or other composition, pressure, and temperature sensors are used to monitor for the presence of conditions that imperil the safe operation of a flow battery system. These sensors are connected to a control system of arbitrary complexity, including a system as simple as a pressure relief valve that communicates with a gas concentration sensor.

To address the safety concerns associated with the buildup of oxygen in flow battery storage tanks, a safety system is provided for use with flow batteries and flow battery systems. In one embodiment, one or more oxygen sensors are placed in the headspace of a flow battery's storage tanks, and a control mechanism of varied complexity responds to specified concentrations of oxygen in the tanks. Additional components of this system, in different embodiments, include temperature sensors placed in the storage tanks. Temperature sensors are useful because combined temperature and oxygen concentration data provides more accurate information about the likelihood of volatility than does oxygen concentration data alone. A further additional component of the system, in another embodiment, includes gas concentration sensors that measure chemical species other than oxygen. Data about the evolution of other chemical species provides information about the chemical reactions occurring in the storage tanks, which further informs whether the device is operating safely. Finally, pressure sensors, in different embodiments, are employed to further determine the state of the gas in the tanks.

A control unit, control system, or control mechanism responding to one or more these sensor readings, in different embodiments, varies from a relatively rudimentary control system to a highly complex control system. In a simple control system having a controller, the controller activates pressure relief valves on the material storage tanks when oxygen concentrations rise above a critical threshold. This activation vents the active gaseous material in the tanks to either a secondary holding tank or the atmosphere. The relief valves can be accompanied by a pump if the pressure in the storage tanks is small relative to the pressure in the surrounding atmosphere. Venting and pumping could be accomplished using rubberized or coated flow passages in order to prevent the formation of a spark that could initiate combustion. In such embodiments, however, the active material in the liquid phase would remain within the tank and could be recovered for future use.

In a more complex control system, the temperature within the tank and chemical species data are employed to estimate the state of the gas in the storage tanks. Pressure relief valves are used to vent gas from the storage tanks when the gas composition in the storage tanks becomes flammable. These relief values are opened until the gas in the interior of the storage tank reaches a specified pressure, temperature, or composition. A relief valve that can be opened or closed repeatedly over specified time intervals permits the continued operation of the flow battery after venting.

Other mechanisms of responding to high oxygen concentrations in the storage tanks, in different embodiments, are employed. For example, a chemically active material with a high surface area is exposed to the gas inside the flow battery storage tank. This active material is used to absorb oxygen or other gas species that increase the risk of combustion. The active material stores the absorbed species in a molecularly inert form, which exists in any phase. The adsorbent or absorbent material is be replaced periodically, or if necessary, during servicing of the flow battery. Such a material includes a design to catalyze a particular reaction in the headspace of a tank. For example, a surface deposited with platinum is used to convert excess H₂ and O₂ gas in the tank head space into H₂O. The catalytic surface can also be heated to increase the rate at which it reacts H₂ and O₂. The exposure of the active material to the gas in the storage tanks is controlled using a sealed valve.

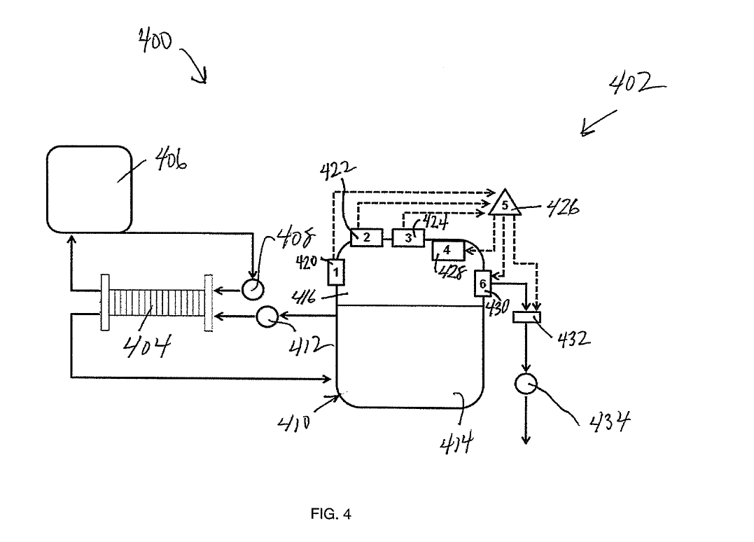

FIG. 4 is a schematic diagram of a flow battery system 400 including a safety system 402. While the illustrated safety system 402 is directed to a Br₂/HBr liquid storage tank in an H₂/Br₂ flow battery system, the safety system 402, in other embodiments, is used with gaseous H₂ storage tanks or other gas storage tanks in flow battery systems that use other active materials.

As illustrated in FIG. 4, the flow battery system 400 includes a flow battery stack 404 operatively coupled to a H₂ storage tank 406, the contents of which are delivered to an input of the battery stack 404 by a pump 408 as necessary. A hydrogen bromide (Br₂/HBr) solution, stored in a combined Br₂/HBr tank 410 is delivered by a pump 412 to a Br₂/HBr input of the battery stack 404. A separate coolant loop (not shown), is provided in different embodiments, to cool the Br₂/HBr solution which flows through the battery stack 404 such as that illustrated in FIG. 2. While FIG. 4 illustrates only few components of a flow battery system, the safety system 402 is used with other configurations of flow battery systems, in different embodiments, and is not limited to the flow battery systems and configurations of FIG. 2 or FIG. 4.

The safety system 402 includes one or more safety components which are configured in a variety of different combinations and in different embodiments. The tank 410 is configured to store a liquid solution 414 of Br₂/HBr solution wherein a portion 416 of the tank 410 is free of liquid to hold gaseous hydrogen/bromine. A gas concentration sensor 420 is operatively coupled to the interior of the tank 410 at a location where gaseous hydrogen/bromine is located under all conditions. The gas concentration sensor 420 includes an electrical connection located externally to the tank such that a gas concentration signal produced by the sensor is accessible. A pressure sensor 422 is similarly situated to provide a sensor signal which is accessible and which provides a current state of pressure existing within the tank 410. One or both of the sensors 420 and 422, in different embodiments, are configured to transmit signals wirelessly.

A pressure relief valve 424 is operatively coupled to the tank 410 such that pressure is relieved when necessary. The pressure relief valve 424, in one embodiment, is a manual pressure relief valve having a preset pressure value, which when exceeded, provides pressure relief in the tank. In another embodiment, the pressure relief valve 424 is electrically controllable, such that a control signal transmitted to and received by the valve 424 causes the valve to relieve pressure.

Each of the sensors 420 and 422 and the pressure relief valve 424 provide respective signals which are received by a controller 426. The controller 426, in one embodiment comprises a microprocessor, ASIC or other type of processing unit. The controller 426 receives the signals of devices 420, 422, and 424, and in response to one or more unsafe conditions sensed by the sensors devices, transmits signals to one or more of a chemical absorber 428, a ventilation exhaust device or system 430, and a chemical scrubber 432. The controller 426 includes a memory (not shown) and is configured to execute instructions responsive to the received input signals to adjust the operation of the chemical absorber 428, the ventilation exhaust device or system 430, and the chemical scrubber 432.

The chemical absorber 428 is configured to absorb a gas disposed in the tank 410. If one or more of the devices 420, 422, and 424 transmits a signal indicating the potentiality of or the occurrence of an unsafe condition, typically an unacceptably high O₂ concentration or pressure, the controller 426 transmits a signal to the absorber 428 to begin the absorption process. The absorber 428, in a different embodiment, is not a controllable device but absorbs the unwanted gas continuously when present.

The ventilation exhaust system 430 is operatively connected to the chemical scrubber 432 through a sealed physical connection configured to deliver hydrogen bromine gas from the tank 410 to the chemical scrubber 432 in response to a signal transmitted by and received from the controller 426. Should one or more of the sensors 420, 422, and 424 indicate a sufficiently unsafe condition, the controller 426 transmits a signal to the ventilation exhaust system 430 to release hydrogen bromine gas from the tank 410 for delivery to the scrubber 432. At substantially the same time, the controller 426 transmits a signal to the scrubber 432 to begin a scrubbing operation in anticipation of the receipt of gas from the tank 410. A pump 434 is coupled to an output of the scrubber 432 which pumps scrubbed gas to atmosphere.

As seen in FIG. 4, one or more oxygen sensors are placed in the head space 416 of the storage tank 410, and connected to the controller 426 or control unit configured to activate either one or more pressure relief valves 424, one or more pumps 430, or to expose chemically absorbent or reactive material to the gas through one or more chemical absorbers 428.

While the disclosure describes an H₂/Br₂ flow battery, the disclosure is applicable to other types of flow battery systems.

It will be appreciated that variants of the above-disclosed and other features and functions, or alternatives thereof, can be desirably combined into many other different systems, applications or methods. Various presently unforeseen or unanticipated alternatives, modifications, variations or improvements can be subsequently made by those skilled in the art that are also intended to be encompassed by the following embodiments. The following embodiments are provided as examples and are not intended to be limiting.

### EMBODIMENTS

### Embodiment 1

A flow battery system and method including a flow battery and a safety system configured to detect for the presence of an unsafe condition.

### Embodiment 2

A flow battery system and method of embodiment 1 wherein the unsafe condition includes the presence of an undesirable gas.

### Embodiment 3

The flow battery system and method of embodiment 2 including a controller configured to trigger an alarm to indicate the presence of the undesirable gas.

### Embodiment 4

A flow battery system and method of embodiment 1 including a control system configured to provide a remedial action in response to the presence of the unsafe condition to ensure that the control system responds accordingly to correct and/or eliminate the unsafe condition.

### Embodiment 5

A flow battery system and method including a flow battery, a safety system, a compressed H₂ storage tank, and a combined Br₂/HBr storage tank, wherein the safety system is configured to determine at least one of a current status of one or both of the storage tanks, detect for the presence of an unsafe condition in one or both of the storage tanks, alarm for, correct and/or eliminate the unsafe condition.

### Embodiment 6

The flow battery system and method of embodiment 5 wherein the safety system includes one or more sensors configured to determine a status of one or both of the storage tanks.

### Embodiment 7

The flow battery system and method of embodiment 6 wherein the one or more sensors includes a gas sensor, a temperature sensor, a pressure sensor.

### Embodiment 8

The flow battery system and method of embodiment 6 further including a pressure relief valve configured to relieve the pressure in one or both of the storage tanks.

### Embodiment 9

The flow battery system and method of embodiment 6 further including one of a chemical absorber and a chemical scrubber.

### Embodiment 10

The flow battery system and method of any one of the embodiments 6, 7, 8, and 9 further comprising a controller configured to respond to the presence of an unsafe condition in one or both of the storage tanks, provide an alarm for, and correct and/or eliminate the unsafe condition.

### Embodiment 11

A safety system and method for a flow battery system configured to detect for the presence of an unsafe condition.

### Embodiment 12

A safety system and method for a flow battery system including a flow battery, a compressed H₂ storage tank, and a combined Br₂/HBr storage tank, wherein the safety system is configured to determine at least one of a current status of one or both of the storage tanks, detect for the presence of an unsafe condition in one or both of the storage tanks, alarm for, correct and/or eliminate the unsafe condition.

What is claimed is:

1. A flow battery system, comprising:
a flow battery including a first electrode and a second electrode disposed within a housing, the flow battery configured to generate electrical energy by passing a first active material over the first electrode and a second active material over the second electrode;
a first reservoir fluidically connected to the housing and configured to store the first active material, the first reservoir positioned remote from the flow battery; and
a safety system operatively connected to the first reservoir; the safety system configured to detect an unsafe condition in the first reservoir and to mitigate the unsafe condition.

2. The flow battery system of claim 1, wherein the flow battery is configured as a redox flow battery and the first active material includes one of hydrogen, bromine, or a solution of bromine and hydrogen bromide.

3. The flow battery system of claim 1, wherein the safety system includes a pressure relief valve operatively connected to the first reservoir, the pressure relieve valve configured to vent at least a portion of the first active material when a pressure within the first reservoir exceeds a predetermined pressure value.

4. The flow battery system of claim 1, wherein the safety system includes at least one sensor positioned in a headspace of the first reservoir to sense a condition of the first active material within the first reservoir, the sensed conditioned including at least one of a gas concentration, a temperature, and a pressure.

5. The flow battery system of claim 4, wherein the at least one sensor includes one or more of:
an oxygen sensor configured to generate a signal indicative of the concentration of oxygen within the first reservoir;
a temperature sensor configured to generate a signal indicative of the temperature within the first reservoir;
a gas concentration sensor configured to generate a signal indicative of the concentration of one or more gases other than oxygen within the first reservoir; and
a pressure sensor configured to generate a signal indicative of the pressure within the first reservoir.

6. The flow battery system of claim 4, wherein the safety system further includes a control unit operatively connected to the at least one sensor, the control unit detecting the unsafe condition when one or more of the gas concentration, the temperature, and the pressure exceeds a predetermined gas concentration value, a predetermined temperature value, and a predetermined pressure value, respectively.

7. The flow battery system of claim 6, wherein the safety system further includes a pressure relieve valve operatively connected to the first reservoir, the control unit configured to actuate the pressure relieve valve to vent the first active material from the first reservoir when the control unit detects the unsafe condition.

8. The flow battery system of claim 7, wherein the safety system further includes a pump configured to facilitate venting of the first active material from the first reservoir.

9. The flow battery system of claim 6, wherein the safety system further includes a ventilation system operatively connected to the first reservoir and configured to vent a gaseous portion of the first active material from the first reservoir, the control unit configured to actuate the ventilation system to release the gaseous portion of the first active material from the first reservoir when the control unit detects the unsafe condition.

10. The flow battery system of claim 9, wherein the ventilation system includes a chemical scrubber configured to scrub the released gaseous portion of the first active material.

11. The flow battery system of claim 9, wherein the control unit is further configured to estimate a state of the first active material by monitoring the temperature within the first reservoir and identifying one or more chemical species in the gaseous portion of the first active material, the control unit detecting the unsafe condition when the gaseous portion of the first active material becomes flammable.

12. The flow battery system of claim 6, wherein the safety system further includes a chemical absorber positioned in the headspace of the first reservoir, the chemical absorber having a surface that includes a chemically active material configured to absorb one or more of oxygen and other gas species that increase the risk of combustion within the first reservoir.

13. The flow battery system of claim 12, wherein the chemical absorber includes a catalytic surface that is one or more of deposited with platinum and heated.

14. The flow battery system of claim 12, wherein the chemical absorber is selectively exposable to a gaseous portion of the first active material via a sealed valve, the control unit configured to actuate the sealed vale to expose the gaseous portion of the first active material when the control unit detects the unsafe condition.

15. A method for operating a flow battery configured to generate electrical energy by passing a first active material over a first electrode and a second active material over a second electrode, the method comprising:
storing the first active material for the flow battery in a first reservoir positioned remote from the flow battery;
monitoring a condition of the first active material stored in the first reservoir and detecting when the condition becomes unsafe; and
mitigating the unsafe condition with a safety system.

16. The method of claim 15, wherein mitigating the unsafe condition includes venting at least a portion of the first active material from the first reservoir when a pressure within the first reservoir exceeds a predetermined pressure value.

17. The method of claim 15, wherein:
monitoring the condition of the first active material includes sensing at least one of a gas concentration, a temperature, and a pressure of the first active material within the first reservoir, and
detecting the unsafe condition includes detecting when one or more of the gas concentration, the temperature, and the pressure exceeds a predetermined gas concentration value, a predetermined temperature value, and a predetermined pressure value, respectively.

18. The method of claim 17, wherein mitigating the unsafe condition includes actuating a ventilation system to vent a gaseous portion of the first active material from the first reservoir when the condition of the first active material becomes unsafe.

19. The method of claim 17, wherein mitigating the unsafe condition includes exposing a gaseous portion of the first active material in the first reservoir to a chemical absorber having a surface that includes a chemically active material, the chemically active materially configured to absorb one or more of oxygen and other gas species that increase the risk of combustion within the first reservoir.

20. The method of claim 15, wherein detecting the unsafe condition includes:
monitoring the temperature within the first reservoir;
identifying one or more chemical species in a gaseous portion of the first active material in the first reservoir;
estimating a state of the gaseous portion of the first active material based on the monitored temperature and the identified one or more chemical species; and
detecting the condition of the first active material is unsafe when the state of the gaseous portion is flammable.
